(19) United States
(12) Patent Application Publication
(10) Pub. No.: US 2011/0223780 A1
(43) Pub. Date: Sep. 15, 2011

(54) Electrical connector for connecting an adaptor board or electrical component to a main printed circuit board

(76) Inventor: James V. Russell, Whitehouse Station, NJ (US)

(21) Appl. No.: 13/065,006

(22) Filed: Mar. 11, 2011

Related U.S. Application Data
(60) Provisional application No. 61/340,277, filed on Mar. 15, 2010.
(60) Provisional application No. 61/340,519, filed on Mar. 18, 2010.

(51) Int. Cl. H01R 12/71

(52) U.S. Cl. 439/66; 439/78

(57) ABSTRACT

An electrical connector electrically connects either an adaptor board or an electrical component to a main circuit board through the use of a thin printed circuit having an array of pads one each side where on one side the pads are connected to a main circuit board by solder balls, solder columns conductive epoxy or any other way practiced in the art and on the other side of the thin circuit the pads are connected to an adaptor board by a conductive compliant elastomeric material. The sides of the thin printed circuit are electrically connected to one another in ways practiced in the art.

### RELATED APPLICATIONS

This is a non provisional application of provisional applications 61/340,277 filed on Mar. 15, 2010 by James V. Russell and 61/340,519 filed on Mar. 18, 2010 by James V. Russell.

### BACKGROUND OF THE INVENTION

1. Field

The present invention relates to an electrical connector. These connectors electrically connect an adaptor board to a main circuit board (main board) where it is necessary to convert the coarse pad arrangement of one with a fine pad arrangement of the other through the use of a thin printed circuit having an array of pads one each side where on one side the pads are connected to a main circuit board by solder balls, solder columns conductive epoxy or any other way practiced in the art and on the other side of the thin circuit the pads are connected to an adaptor board by a conductive compliant elastomer. The sides of the thin printed circuit are electrically connected to one another in ways practiced in the art.

2. The Related Art

U.S. Pat. No. 6,702,587 to Weiss et al. (the '587 patent) relates to an electrical connector using an anisotropic conductive elastomer (ACE). The ACE is provided in sheet form and conducts electricity in the z axis on a consistent pitch over the entire surface of the conducting region. This prevents the device in the '587 patent from having the ability to route conducting traces on the interface sides of the adaptor board and the main board.

### SUMMARY

The present invention provides an electrical connector connecting an adaptor board to a main circuit board where it is necessary to convert the coarse pad arrangement of one with a fine pad arrangement of the other through the use of a thin printed circuit having an array of pads one on each side where on one side the pads are connected to a main circuit board by solder balls, solder columns, conductive epoxy or any other way practiced in the art and on the other side of the thin circuit the pads are connected to an adaptor board by a conductive compliant elastomer.

### BRIEF DESCRIPTION OF THE DRAWINGS

FIGS. 1-4 illustrate a first embodiment of the present disclosure using pads with elastomeric material for attachment to the adaptor board in which:

FIG. 1 is a top view of a first embodiment of the present disclosure;

FIG. 2 is a bottom view of the first embodiment of the present disclosure;

FIG. 3 is a perspective view of the first embodiment of FIG. 1; FIG. 4 is a sectional view along the lines A-A of FIG. 1;

FIGS. 5-8 illustrate a second embodiment of the present disclosure using contact pads with aspirates with conductive elastomeric material for attachment to the adaptor board in which:

FIG. 5 is a top view of a second embodiment of the present disclosure;

FIG. 6 is a bottom view of the second embodiment of the present disclosure;

FIG. 7 is a perspective view of the second embodiment of FIG. 5; and

FIG. 8 is a sectional view along the lines B-B of FIG. 5.

### DETAILED DESCRIPTION OF THE PREFERRED EMBODIMENT(S)

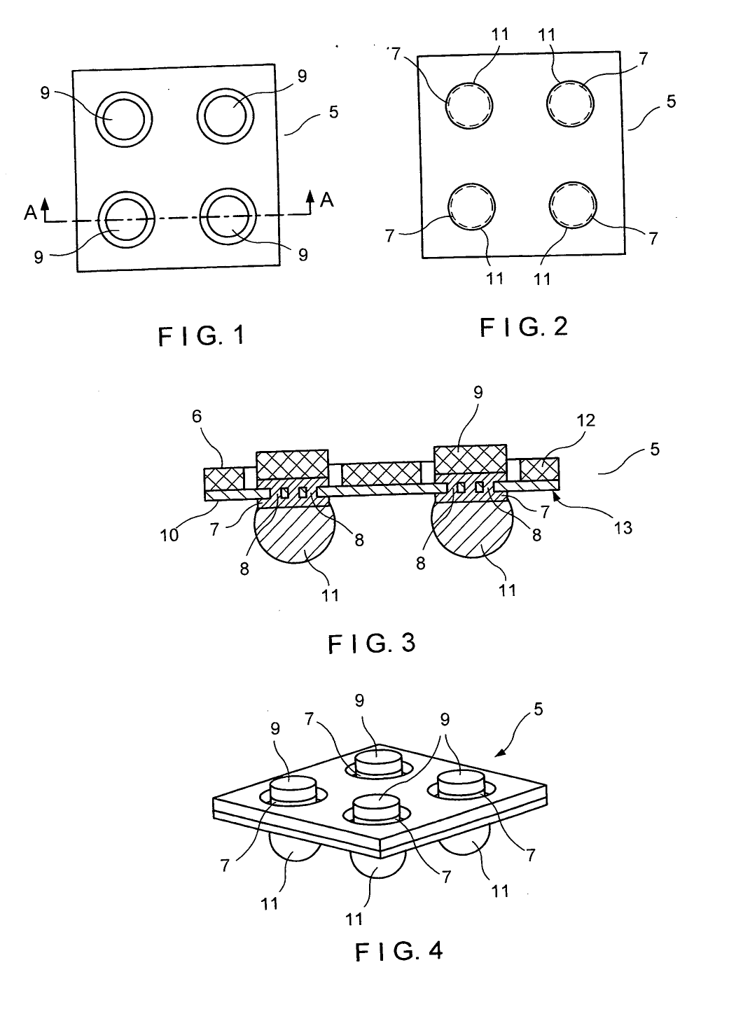

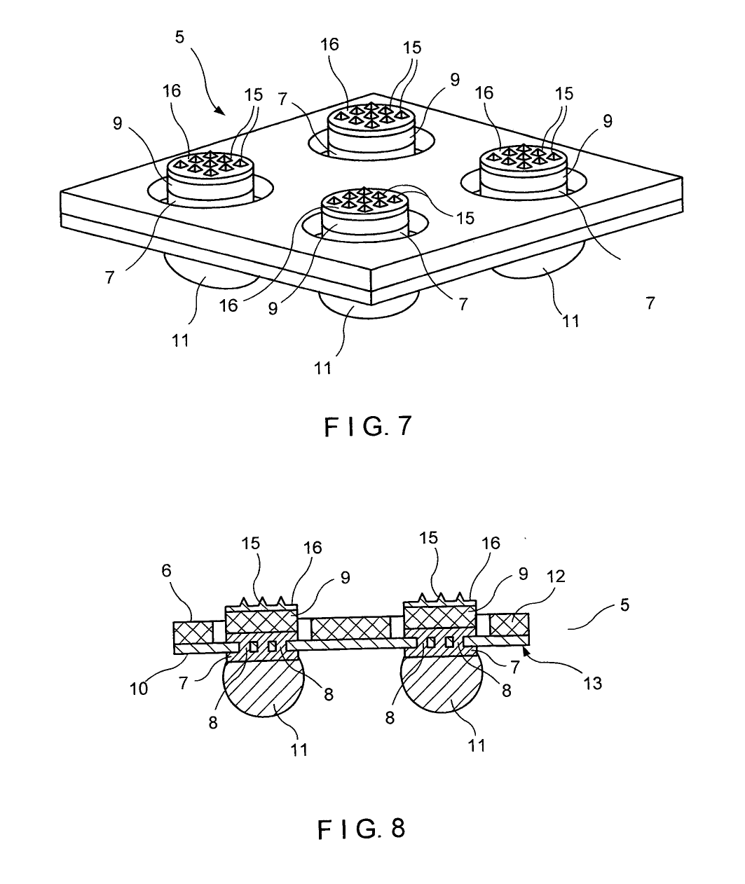

Referring now to the drawings of FIGS. 1-8, FIGS. 1-4 illustrate a first embodiment of the present disclosure. An electrical connector 5 is formed for connecting an adaptor board to a main circuit board where the electrical connector 5 is formed, from a thin printed circuit or printed circuit board 5 as shown in top, bottom and perspective views (FIGS. 1, 2 and 3, respectively). As shown in FIG. 4, a sectional view of lines A-A of FIG. 1, the thin printed circuit board 5 is provided on the top surface 6 of the thin printed circuit board 5 with contact pads 7 with plated through hole vias 8. The pads have a conductive elastomeric material 9 on the pads' top surface which can be either isotropic elastomeric material or anisotropic elastomeric material for attachment and electrical contact with an adaptor board. The bottom surface 10 of the thin printed circuit board has contact pads 7 with either solder balls 11, column conductive epoxy or any other conductive material practiced in the art for stabling an electrical connection with the main circuit board to be located and placed under the thin printed circuit board. The top 6 of the thin circuit board 5 also has compression hard stop 12 and dielectric material 13 under the compression hard stop 12 such as but not limited to a Kapton substrate 13. The hard compression stop prevents too much compression pressure over the dielectric material and on the elastomeric material. The pads 7 on each side 6, 10 of the thin printed circuit 5 are electrically connected to one another in ways practiced in the art.

By compressing the boards (adaptor board or electrical component and main circuit board) together it is possible to provide an electrical connection between the adaptor board (or electrical component) and the main circuit board and convert the pads 7 on each board's surface connection from coarse to fine or vice verse by use of the intermediate connector—the modified PC board with elastomeric material.

In addition to converting the pitch by connecting fine pads to coarse pads and vice verse, the present disclosure also provides for rerouting the electrical connections from the pins connected to the pins of a test circuit (such as an IC chip) housed in a socket of a mechanical compression structure to the pads of the adaptor board (or electrical component) and to the pads of the main circuit board.

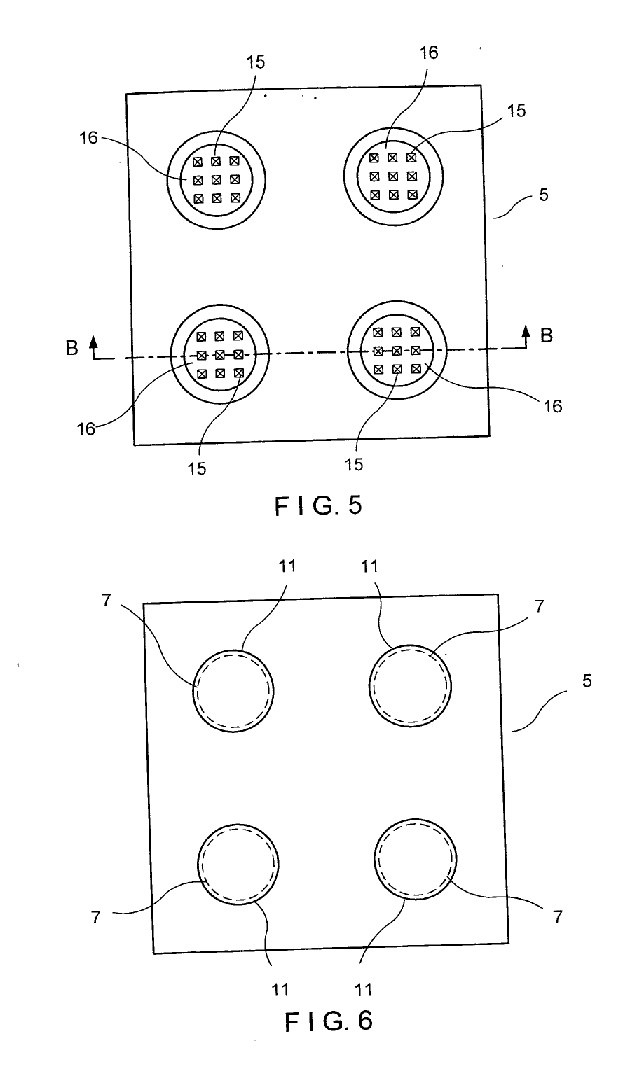

FIGS. 5-8, illustrate a second embodiment of the present disclosure in which the contact pad on top surface of the thin printed circuit 5 that is used for the electrical connector between the main circuit board and the adaptor board has aspirates 15 as well as conductive elastomers 9 for attaching the conductive elastomeric material 9 with the adaptor board. Otherwise the description for this electrical connector is identical with the embodiment of FIGS. 1-4 described above and therefore the same element numbers and descriptions for FIGS. 5-8 as were used in the description for FIGS. 1-4. Again, an electrical connector 5 is formed for connecting an adapter board to a main circuit board where the electrical connector 5 is formed from a thin printed circuit or printed circuit board 5 as shown in top, bottom and perspective views (FIGS. 1, 2 and 3, respectively). As shown in FIG. 4, a sectional view of lines A-A of FIG. 1, the thin printed circuit board 5 is provided on the top surface 6 of the thin printed circuit board 5 with contact pads 7—this time with aspirates 15 in attaching the connection with elastomeric material 9 in place with the adaptor board—with plated through hole vias 8. The pads 7 have a conductive elastomeric material 9 on the pads' top surface 6 which can be either isotropic elastomeric material or anisotropic elastomeric material for attachment and electrical contact with an adaptor board. The bottom surface 10 of the thin printed circuit board 5 has contact pads 7 with either solder balls 11, column conductive epoxy or any other conductive material practiced in the art for stabling an electrical connection with the main circuit board to be located and placed under the thin printed circuit board. The top 6 of the thin circuit board 5 also has a compression hard stop 12 and dielectric material 13 under the compression hard stop such as but not limited to a Kapton substrate 13. The hard compression stop 12 prevents too much compression pressure over the dielectric material 13 and on the elastomeric material 9. The pads 7 on each side of the thin printed circuit 5 are electrically connected to one another in ways practiced in the art.

By compressing the boards together it is possible to provide an electrical connection between the adaptor board and the main circuit board and convert the pads on each board's surface connection from coarse to fine or vice verse by use of the intermediate connector—the modified PC board with elastomeric material 9.

In addition to converting the pitch by connecting fine pads to coarse pads and vice verse, the present disclosure also provides for rerouting the electrical connections from the pins connected to the pins of a test circuit (such as an IC chip) housed in a socket of a mechanical compression structure to the pads of the adaptor board and to the pads of the main circuit board.

While presently preferred embodiments have been described for the purposes of the disclosure, it is understood that numerous changes in the arrangement of apparatus parts can be made by those skilled in the art. Such changes are encompassed within the spirit of the invention as defined by the appended claims.

1. An electrical connector for providing an electrical connection between an adaptor board and a main circuit board, comprising:
an electrical connector formed as printed circuit board having an array of pads on its top surface and on its bottom surface with conductive elastomeric material on top of said pads on surface for connection to an adaptor board and with suitable conductive material on said other surface for electrical conduction with a main circuit board wherein said pads on each side of said electrical connector are electrically connected to each other to provide connection between said adaptor board and said main circuit board.

2. The electrical connector according to claim 1 wherein instead of an adaptor board an electrical component is connected by said electrical connector to said main circuit board.

3. The electrical connector according to claim 1 wherein said elastomeric material is anistropic elastomeric material.

4. The electrical connector according to claim 1 wherein said elastomeric material is isotropic elastomeric material.

5. The electrical connector according to claim 1 wherein said printed circuit board includes a compression hard stop formed of a dielectric material to prevent over compression of the elastomeric material thereby preserving longevity of the elastomeric material and preventing the elastomeric material from shorting adjacent pads.

6. The electrical connector according to claim 5 wherein said dielectric material is formed of Kapton.

7. The electrical connector according to claim 1 wherein said pads on said top surface of said printed circuit board has aspirates as well as the elastomeric material for attaching the elastomeric material to the adaptor board.
